(19) United States
(12) Patent Application Publication
(10) Pub. No.: US 2011/0048339 A1
(43) Pub. Date: Mar. 3, 2011

(54) Non-Slip Disposable Pet Boot

(76) Inventor: Mary Quinn, Dade City, FL (US)

(21) Appl. No.: 12/548,799

(22) Filed: Aug. 27, 2009

(51) Int. Cl. A01K 13/00; A01K 29/00

(52) U.S. Cl. 119/850

(57) ABSTRACT

The present invention relates to a non-slip disposable pet boot designed primarily for indoor use to help dogs and other pets walk on tile, laminate, wood, or other slippery surfaces. The pet boot of the present invention may be slipped over a cast or bandage and is especially useful for pets that have spinal injuries, arthritis, orthopedic surgery, and the like, to help them walk more securely. The pet boot is made of an open weave, breathable, polymer coated polyester textile. The boot is secured on the pet's foot by a reusable Velcro strap which is wrapped around the upper portion of the boot and the pet's leg to ensure a secure fit, but does not constrict the pet's leg as do ties or elastic bands.

The present invention relates to a non-slip disposable pet boot designed primarily for in-house use to help dogs and other pets walk on tile, laminate, wood, or other slippery surfaces. The boots are especially useful for pets that have spinal injuries, arthritis, degenerative myelopathy, orthopedic surgery, and the like. The pet boot of the present invention may be slipped over a cast or bandage to help with stability. Other uses may be prescribed by a veterinarian.

The boots are made of a breathable polymer coated polyester textile, which is environmentally safe and biodegradable. Each boot is made of a single piece of the breathable, loosely woven polymer coated polyester textile, which is hemmed at the top to make a smooth upper opening, folded inside out, and stitched along the bottom and side edges, and then turned right side out to make a simple boot. The open weave of the material allows outdoor use and dries quickly when washed. The boots are made in seven sizes, as measured around the circumference of the paw, ranging from Tiny 2″, Extra Small 3″, Small 4″, Medium 5″, Large 6″, Extra Large 7″, to Giant 8″. The boots are secured on the pet's feet by reusable Velcro straps which are wrapped around the upper portion of the boot and the pet's leg to ensure a secure fit, but which do not constrict the pet's leg as ties or elastic bands do.

The disposable non-slip boot of the present invention is very light weight, is easy to put on the pet's feet, has superior traction on wood floors, and is so comfortable and breathable that pets may not realize they have anything on their feet. In addition they are less expensive, less cumbersome, and cooler than other pet boots currently on the market. The pet boot of the present invention may be placed over a cast or bandage on the paws of injured pets who have difficulty moving around because of casts or bandages on their paws. The durability of the boot is 2-6 days depending on the pet's activity. The pet boot of the present invention also is made to be affordable so that dirty, worn out, or lost boots are readily replaced.

Custom orders based on the circumference of the paw may be obtained if pre-made sizes do not fit the pet.

What is claimed is:

1. A disposable, light weight, non-slip pet boot to assist dogs and other pets in walking on slippery indoor floors.

2. The disposable, light weight, non-slip pet boot of claim 1, wherein the boot is especially useful for pets that have spinal injuries, arthritis, degenerative myelopathy, orthopedic surgery, and other injuries as prescribed by a veterinarian.

3. The disposable, light weight, non-slip pet boot of claims 1 and 2, which may be placed over a cast or bandage on the paws of injured pets who have difficulty moving around because of the cast or bandage.

4. The disposable, light weight, non-slip pet boot of claims 1 through 3 which is easy to put on a pet's feet, is comfortable, and has superior traction on wood floors.

5. The disposable, light weight, non-slip pet boot of claims 1 through 4, wherein the boot is made of a breathable, loosely woven polymer coated polyester textile, which is washable, and environmentally safe and biodegradable.

6. The disposable, light weight, non-slip pet boot of claims 1 through 5, wherein the boot is secured to the pet's leg with a Velcro strap, which does not constrict the pet's leg as do ties or elastic bands.

7. The disposable, light weight pet boot of claims 1 through 6, wherein the durability of the boot is 2 to 6 days depending on the pet's activity.

8. The disposable, light weight, non-slip pet boot of claims 1 through 7, wherein the loose weave of the polymer coated polyester material allows some outdoor use, but is not durable enough for long term outdoor use, and dries quickly when washed.

9. The disposable, light weight, non-slip pet boot of claims 1 through 8, which is less expensive, less cumbersome, and cooler than other pet boots currently on the market.

10. The disposable, light weight, non-slip pet boot of claims 1 through 9, which is affordable so that a dirty, worn out, or lost boot may be readily replaced.

11. The disposable, light weight, non-slip pet boot of claims 1 through 10, which is made in seven sizes ranging from Tiny 2″ to Giant 8″ to fit the feet of most sizes of pet, and also may be custom ordered if the standard sizes do not fit the pet.
